(19) United States
(12) Patent Application Publication
(10) Pub. No.: US 2003/0189799 A1
(43) Pub. Date: Oct. 9, 2003

(54) Magnetoresistive head and a method for manufacturing of the same

(76) Inventors: Yasunobu Yanagisawa, Odawara (JP); Akira Morinaga, Odawara (JP); Masatoshi Arasawa, Odawara (JP); Shuichi Kojima, Hiratsuka (JP); Makoto Morijiri, Naka (JP)

Correspondence Address: Mattingly, Stanger & Malur, P.C., Suite 370, 1800 Diagonal Road, Alexandria, VA, 22314, US

(21) Appl. No.: 10/219,273

(22) Filed: Aug. 16, 2002

(30) Foreign Application Priority Data
Apr. 8, 2002 (JP) 2002-104653

(51) Int. Cl. G11B 5/39

(52) U.S. Cl. 360/322; 29/603.18

(57) ABSTRACT

A magnetoresistive reproducing head is manufactured by forming a magnetoresistive film and a lead layer continuously, then etching only the lead layer by using a first layer photo-resist pattern, forming a second layer photo-resistive pattern while leaving the first layer photo-resist pattern, etching the magnetoresistive film and then forming a domain control film and an outer lead layer, thereby enabling to avoid the effect at all on the positional relation between the lead layer and domain control film, whereby a head in which the riding amount of the lead layer on the magnetoresistive film is in right-to-left symmetry and the sensitivity profile is in right-to-left symmetry can be manufactured at a good yield.

### BACKGROUND OF THE INVENTION

1. Field of the Invention

The present invention relates to a constitution of a magnetoresistive head mounted on a magnetic disk storage apparatus and a method for manufacturing the magnetoresistive reproducing head and, in particular, it relates to a magnetoresistive reproducing head and a manufacturing method thereof.

2. Description of the Related Art

Along with improvement in the surface recording density of magnetic disk storage apparatus, a magnetoresistive head of a structure in which an inductive recording magnetic head for writing and a magnetoresistive reproducing head for reading are laminated as a hybrid thin film magnetic head on a substrate has been put to practical use.

The magnetoresistive reproducing head has a structure of flowing a current to a magnetoresistive film that changes the resistance value depending on incident magnetic fluxes and read the changes by converting the change of the magnetic fluxes into the change of the resistance. For keeping a proportional relation between the change of resistance and inputted magnetic flux in the magnetoresistive film, it has been known that the magnetoresistive film has to form a single domain with no magnetic walls.

For keeping the magnetoresistive film in a state of the single domain, a structure of disposing a permanent magnet referred to as a domain control film on both ends of a magnetoresistive film is predominant at present, which is formed by continuous film deposition using a magnetic domain control film and an identical resist pattern for an electrode in view of simplicity and convenience of manufacture. The structure formed by the process described above is generally referred as an abutted junction structure.

For improving the recording density, it is necessary to reduce the size of a device, however, magnetic domain rotation is restricted at the end of the magnetoresistive film by the domain control film in the abutted junction structure used so far. As a result, ends of the magnetoresistive film have scarce sensitivity and, as the size of the device is reduced, the end region of a relatively low sensitivity occupies a major part of the device to abruptly lower the sensitivity.

To solve the problem, it has been proposed a structure of extending an electrode from the end to the inside of the magnetoresistive film and flowing current only to the central portion of a track at high sensitivity. This is disclosed, for example, in U.S. Pat. No. 5,206,590.

For attaining the structure described above, etching, of the magnetoresistive film, and formation of the domain control film and formation of the electrode have to be conducted by photolithographic steps for twice. Accordingly, the amount of the electrode riding over the magnetoresistive film depends on the alignment accuracy of the photolithography to bring about a problem that the amount of riding is different between right and left portions to make the sensitivity profile asymmetric with respect to right and left.

### SUMMARY OF THE INVENTION

It is a first object of the invention to overcome the problem of the existent magnetoresistive reproducing head described above.

It is a second object of the invention to provide a method of manufacturing a magnetoresistive reproducing head and in which the amount of electrodes riding on the magnetoresistive film is uniform with respect to right and left portions, as well as a method of manufacturing a magnetoresistive head.

It is a third object of the invention to provide a magnetoresistive head and a magnetoresistive reproducing head having a structure in which the amount of electrode riding on the magnetoresistive film is uniform with respect to right and left portions and is 100 nm or less.

For attaining the foregoing object, in accordance with this invention, the electrode riding portion and the electrode interval are decided by the first photolithographic step, and the domain control film and the lead layer are formed by the second photolithographic step.

### BRIEF DESCRIPTION OF THE DRAWINGS

FIG. 1A to FIG. 1G are production step charts showing a first example of this invention;

FIG. 2A to FIG. 2G are production step charts showing a second example of this invention;

FIG. 3A and FIG. 3B are schematic views showing a state in which misalignment is caused in a two layered resist pattern;

FIG. 4 is a schematic constitutional view of a hybrid magnetic head applied with a magnetoresistive reproducing head obtained by the manufacturing method according to this invention; and

FIG. 5 is a constitutional view illustrating a magnetic disk storage apparatus mounting a magnetoresistive reproducing head obtained by the manufacturing method according to this invention.

### DESCRIPTION OF THE PREFERRED EMBODIMENTS

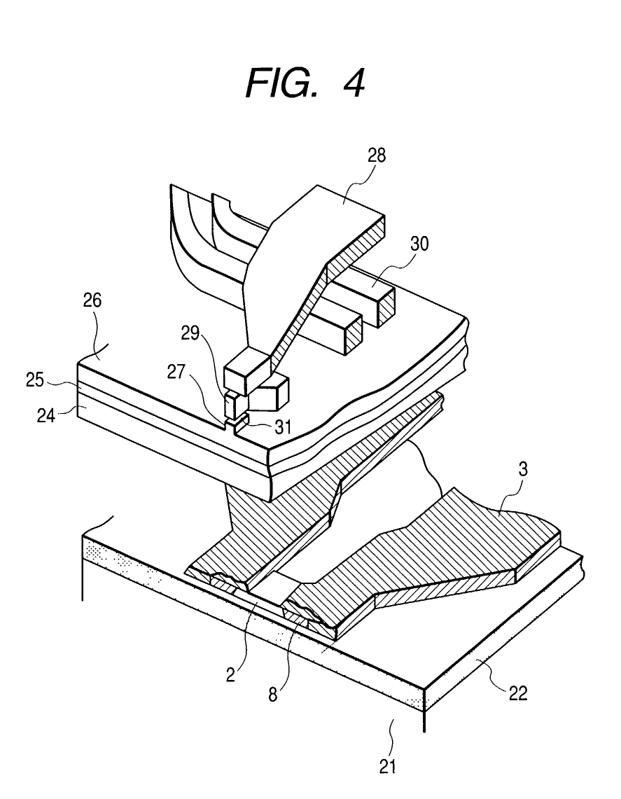

FIG. 4 is a schematic constitutional view of a hybrid magnetic head applied with a magnetoresistive reproducing head manufactured by the method according to this invention.

The hybrid head includes: a magnetoresistive reproducing head in which a lower magnetic shield 22; a magnetoresistive film 2 by way of a lower gap film (not illustrated); a domain control film 8; a lead layer 3 and an upper magnetic shield film 24 by way of an upper gap film (not illustrated) are formed on a substrate 21 also serving as a head slider; and an inductive recording head in which a lower magnetic film 26 and an upper magnetic film 28 are formed by way of an insulation film 25 and coil 30 is formed between them by way of an insulative film. Numeral 27 is a lower magnetic pole protruded from the lower magnetic film 26, 29 is a top end magnetic pole of the upper magnetic film 28 and 31 is a magnetic gap formed between the lower magnetic pole 27 and the top end magnetic pole 29.

A method of manufacturing a magnetoresistive reproducing head as a first example according to this invention is to be explained.

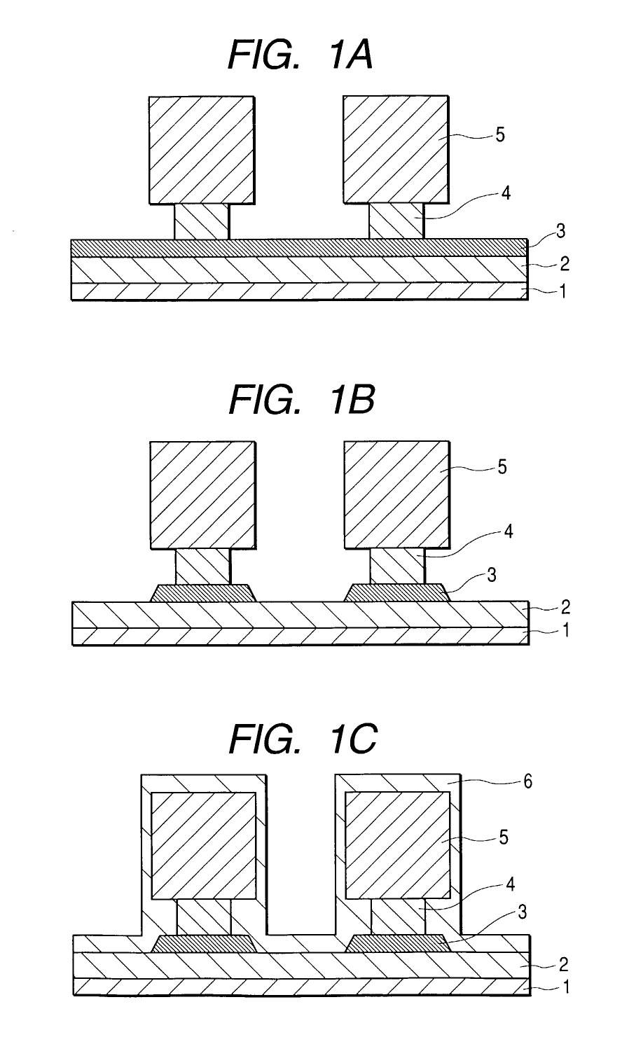

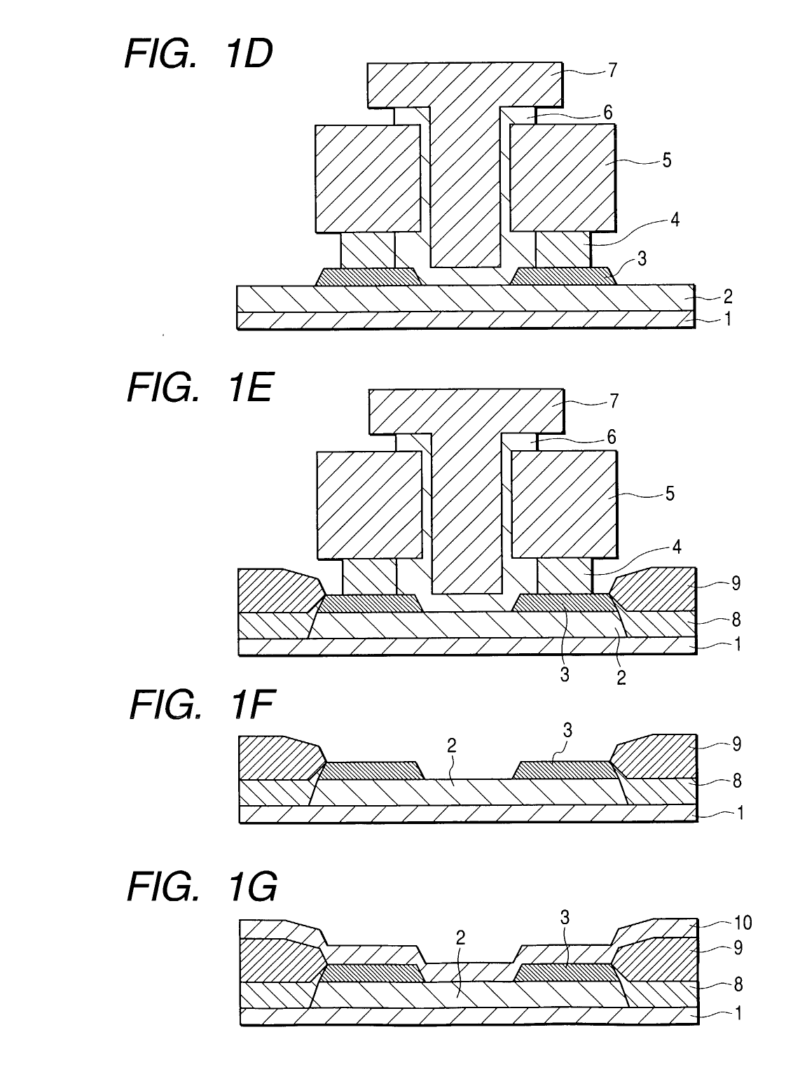

In FIG. 1A, a magnetoresistive film 2 and an lead layer 3 are formed on a lower gap film 1 by a method such as sputtering or vacuum vapor deposition. The magnetoresistive film 2 and the lead layer 3 are deposited continuously under a reduced pressure to prevent increase of the contact resistance. An oxide such as Al₂O₃ and SiO₂ or a mixture or a lamination film thereof is used for the lower gap film 1 and it is formed to have a thickness of about 5 to 30 nm by sputtering, a vacuum vapor deposition method or a CVD method.

The magnetoresistive film 2 is a film comprising an anti-ferromagnetic film, a pinned layer, a conductive non-magnetic film and a free layer. Ta may be laminated as a protective film or Ru which is less removed by dry etching and can function as a stopper upon etching may be laminated stacked on the magnetoresistive film 2.

The lead layer 3 is desirably made of a material having a low resistivity and high electromigration resistance. For example, Ta, W, Ir, Rt, Ru, Rh, Nb, Mo or an alloy thereof, or a laminate film of the metal described above with a low resistance material such as Au, Ag or Cu is used.

Then, first photo-resist patterns 4, 5 of a shape shown in FIG. 1A are formed by laminating a photo-resist 5 and a photo-resist 4 having no sensitivity to exposure and of a higher solubility to a liquid developer than the photo-resist 5, and conducting exposure and development.

Successively, as shown in FIG. 1B, only the lead layer 3 is removed by the combination of milling, ion beam etching or dry etching. The width of the lead layer 3 below the first photo-resist patterns 4 and 5 is set to 100 nm or less. In this step, it is necessary to remove only the lead layer 3 without damaging the magnetoresistive film 2, and the lead layer 3 is formed as a multi-layered film such as Ta/Au/Ta/Ru, from which Ta/Au is removed by ion beam etching using Ta/Ru as an etching stopper and the remaining Ta/Ru is removed by dry etching using an F series gas or the like. For removing only the electrode film 3, it is effective to conduct end point detection by SIMS or emission spectroscopy.

In this process, the end of the lead layer 3 can be made closer to vertical by optimizing etching conditions, and as the end is closer to vertical, current tends to be concentrated more to a central portion of the magnetoresistive film 2, to improve the sensitivity profile.

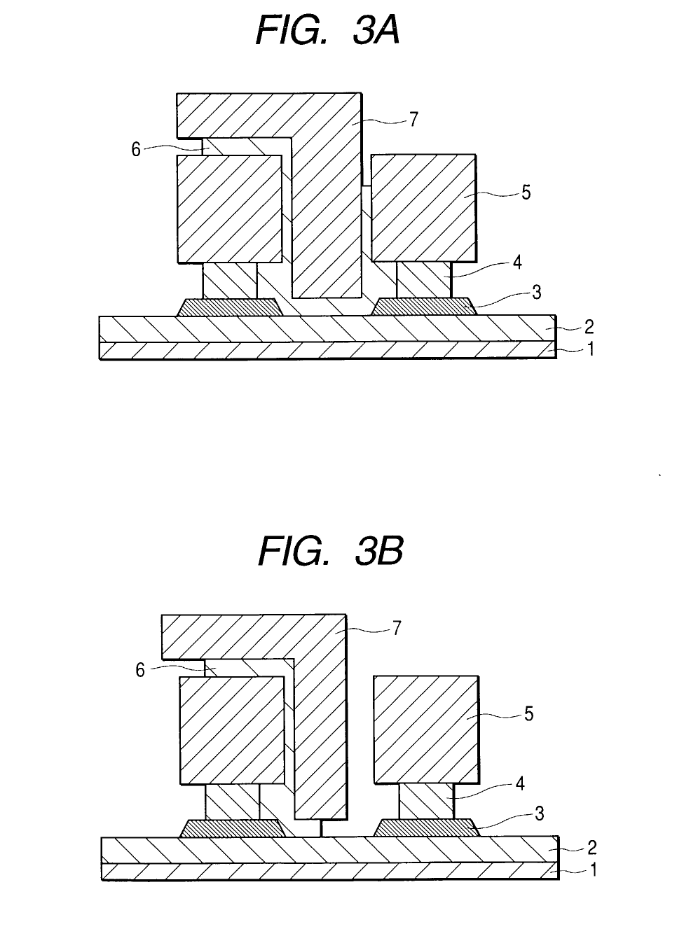

Further, as shown in FIG. 1C and FIG. 1D, after coating a photo-resist 6, a photo-resist 7 is coated and exposure and development are conducted to form a second photo-resist pattern. In this step, it may suffice that the pattern formed by the photo-resist 7 fills a portion between the two patterns, and the dimensional accuracy and the alignment accuracy may be low. Even when misalignment is caused to an extent as shown in FIG. 3A, it gives no effect on the riding amount (width) of the lead layer 3 unless a large misalignment as causing a gap between the photo-resist 5 and the photo-resist 6 and 7 is caused as shown in FIG. 3B.

Successively, the magnetoresistive film 2 is etched as shown in FIG. 1E by using first and second photo-resist patterns shown in FIG. 1D by milling or dry etching such as ion beam etching and, successively, the domain control film 8 and the outer lead layer 9 are formed, for example, by sputtering, vacuum vapor deposition or ion beam deposition. The lead layer 3 and the outer lead layer 9 are connected electrically.

The domain control film comprise a Co—Cr alloy, Co—Cr—Pt alloy or Sm alloy. Further, the outer lead layer 9 uses, for example, Ta, W, Ir, Rt, Ru, Rh, Nb, Mo or an alloy thereof, or a laminate film of the metal and a low resistance material such as Au, Ag or Cu.

Then, the laminate is dipped in a photo-resist peeling solution or a peeling solution is blown to the laminate to remove the first and the second photo-resist patterns as shown in FIG. 1F.

Further, as shown in FIG. 1G, an upper gap film 10 is formed to a thickness of about 5 to 30 nm with an oxide such as Al₂O₃ or SiO₂, or a mixture or a laminate film thereof is formed by sputtering, vacuum vapor deposition or CVD above the magnetoresistive film 2, the lead layer 3 and the outer lead layer 9, thereby capable of forming a magnetoresistive reproducing head in which the lead layer 3 rides on the magnetoresistive film 2 in right-to-left symmetry.

In the example described above, although not illustrated, a lower magnetic shield 22 is formed below the lower gap film 1 and an upper magnetic shield 24 is formed on the upper gap film 10 as shown in FIG. 4.

When an inductive recording head is stacked on the thus formed magnetoresistive reproducing head as shown in FIG. 4, the manufacture of a magnetoresistive head as a hybrid head is completed.

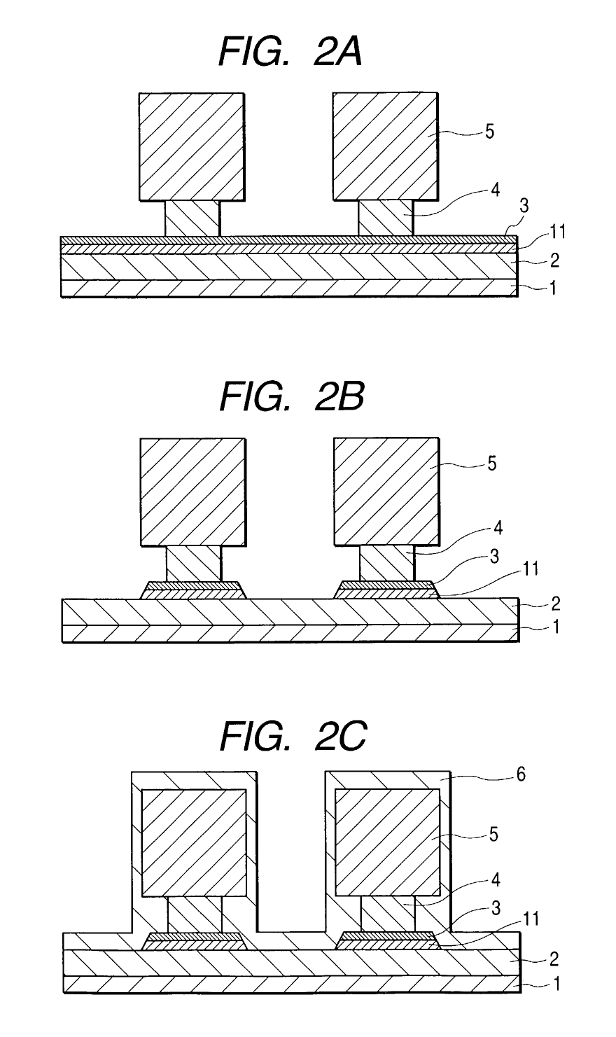

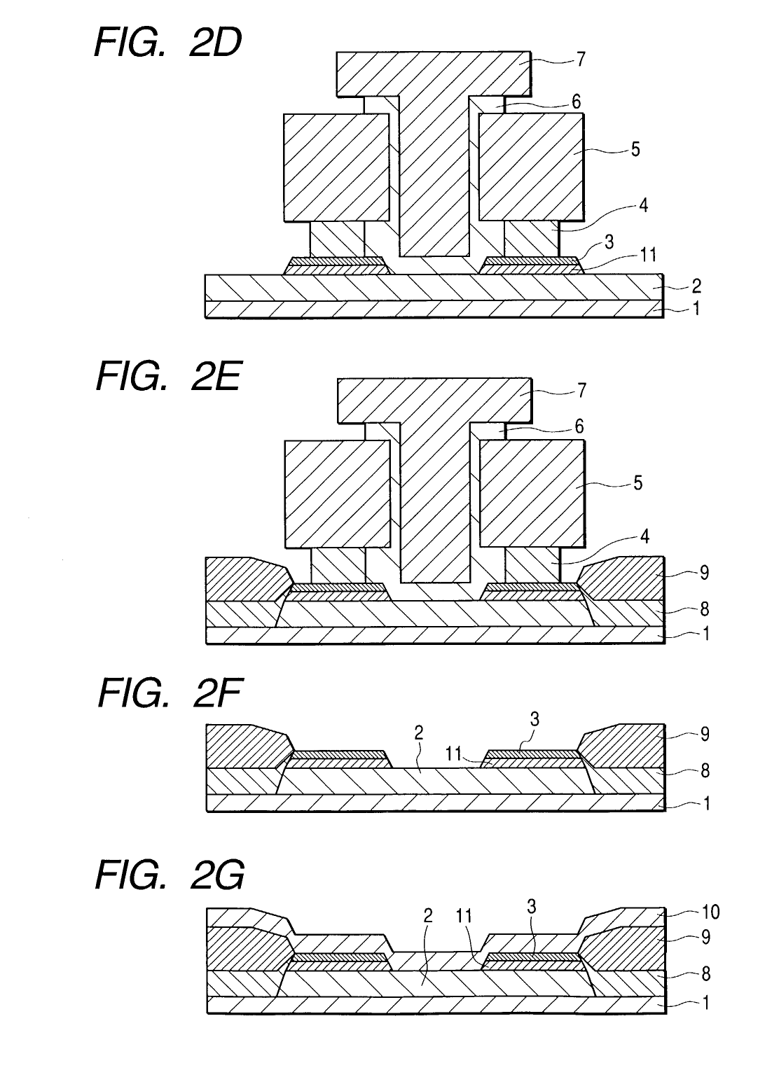

Then, a second example of this invention is to be explained with reference to FIGS. 2A-2G.

The second example is different from the first example in that an anti-ferromagnetic film 11 is formed between a magnetoresistive film 2 and a lead layer 3 as shown in FIG. 2A. The magnetoresistive film 2, the anti-ferromagnetic film 11 and the lead layer 3 are formed continuously above the lower gap film 1 by a method such as sputtering or vacuum vapor deposition. An oxide such as Al₂O₃ or SiO₂, or a mixture or a laminate film thereof is used for the lower gap film 1, and formed to a thickness of about 5 to 30 nm by sputtering, vacuum vapor deposition or CVD.

The magnetoresistive film 2 is a film comprising an anti-ferromagnetic film, a pinned layer, a conductive non-magnetic film and a free layer. Ta may be laminated as a protective film, or Ru which is less removed by dry etching and can serve as a stopper upon etching may be laminated above the magnetoresistive film 2.

Also for the lead layer 3, those of low resistivity and high electromigration resistance are preferred as in Example 1. For example, Ta, W, Ir, Rt, Ru, Rh, Nb, Mo or an alloy thereof, or a laminate film of the metal described above with a low resistance material such as Au, Ag or Cu is used.

It is necessary to select a material for the anti-ferromagnetic film 11 of different blocking temperature from the anti-ferromagnetic film used in the magnetoresistive film 2.

Then, in the same manner as in Example 1, a photo-resist 4 not having sensitivity to exposure and has higher solubility to a liquid developer than a photo-resist 5 and the photo-resist 5 are laminated, and exposure and development are conducted to form a first photo-resist pattern as shown in FIG. 2A.

Only the lead layer 3 and the anti-ferromagnetic film 11 are removed by the combination of methods such as milling, ion beam etching or dry etching as shown in FIG. 2B. The width for the lead layer 3 is set to 100 nm or less. In order to remove only the lead layer 3 and the anti-ferromagnetic film 11, it is effective to conduct end point detection by SIMS or emission spectroscopy.

In this case, it is possible to approach the ends of the lead layer 3 and the anti-ferromagnetic film 11 more vertical by optimizing the etching conditions in the same manner as in Example 1, and the current tends to be concentrated to the central portion of the magnetoresistive film 2 as they approach more to the vertical state, to improve the sensitivity profile.

The production process from FIG. 2C to FIG. 2G is identical with the process shown by FIG. 1C to FIG. 1G in the first example.

By way of the process described above, a magnetoresistive reproducing head in which the lead layer rises over the magnetoresistive film 2 in right-to-left symmetry can be formed.

Also in the second example, although not illustrated, a lower magnetic shield 22 is formed below the lower gap film 1, while an upper magnetic shield lead 24 is formed over the upper gap film 10 as shown in FIG. 4.

Further, when an inductive recording head is stacked above the magnetoresistive reproducing head, the manufacturing of a magnetoresistive reproducing head as a hybrid head is completed.

As described above, the manufacturing method according to this invention can provide a further effect when the recording density is improved and the track width is reduced, and is applicable also to a magnetic head of a type in which CPP-GMR or TMR device is disposed.

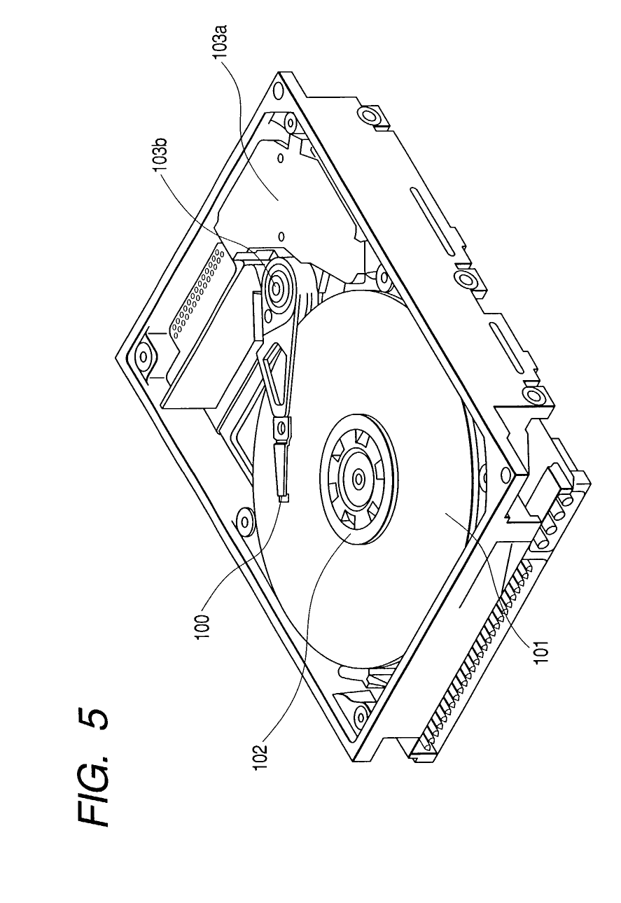

FIG. 5 shows a magnetic disk storage apparatus mounting a magnetoresistive reproducing head according to the first and the second examples. A magnetoresistive reproducing head 100 as a hybrid head is supported by a head support mechanism 103b, rotationally driven by a voice coil motor 103a and positioned to an optional track of a magnetic disk 101 which is rotationally driven by a driving section 102 such as a spindle motor, to conduct recording and reproduction of information.

As has been described above, since the process of stacking photo-resist patterns in two layers is adopted, misalignment is tolerated, rising of the leads on the magnetoresistive film is made symmetrical with respect to right-to-left portions, and a magnetoresistive reproducing head having right-to-left symmetry sensitivity profile can be manufactured at a good yield.

What is claimed is:

1. A method of manufacturing a magnetoresistive reproducing head comprising the steps of:
forming a magnetoresistive film and a lead layer on a lower gap film;
forming a first layer photo-resist pattern at a distance above the lead layer;
etching said lead layer by using the photo-resist pattern;
forming a second layer photo-resist pattern on said magnetoresistive film removed with said lead layer and said first layer photo-resist pattern;
etching said magnetoresistive film by using said first layer and said second layer photo-resist patterns, thereby forming a domain control film and an outer lead layer to a portion where said magnetoresistive film has been removed;
removing said first layer and said second layer photo-resist patterns; and
forming an upper gap layer above said magnetoresistive film, said lead layer and said outer lead layer.

2. A method of manufacturing a magnetoresistive reproducing head according to claim 1, wherein said magnetoresistive film has an anti-ferromagnetic film, a pinned layer, a conductive non-magnetic film and a free layer.

3. A method of manufacturing a magnetoresistive reproducing head according to claim 1, wherein a lower magnetic shield is formed below said lower gap film and an upper magnetic shield formed above said upper gap film.

4. A method of manufacturing a magnetoresistive reproducing head according to claim 1, wherein said magnetoresistive film and said lead layer are formed continuously without breaking vacuum.

5. A method of manufacturing a magnetoresistive reproducing head comprising the steps of:
forming a lower magnetic shield on a substrate;
forming a lower gap film on said lower magnetic shield;
forming a magnetoresistive film and a lead layer on said lower gap film;
forming a first layer photo-resist pattern with a distance above said lead layer;
etching said lead layer by using the photo-resist pattern;
forming a second layer photo-resist pattern on said magnetoresistive film removed with said lead layer and said first layer photo-resist pattern;
etching said magnetoresistive film by using said first layer and said second layer photo-resist patterns, thereby forming a domain control film and an outer lead layer to a portion where said magnetoresistive film has been removed;
removing said first layer and said second layer photo-resist patterns;
forming an upper gap layer above said magnetoresistive film, said lead layer and said outer lead layer;
forming an upper magnetic shield on said upper gap film; and
forming an inductive recording head having: a lower magnetic layer and an upper magnetic layer formed on said upper magnetic shield by way of an insulator film; and a coil disposed between said lower magnetic film and said upper magnetic film by way of a magnetic gap and an insulation film.

6. A method of manufacturing a magnetoresistive reproducing head comprising the steps of:
forming a magnetoresistive film having an anti-ferromagnetic film, a pinned layer, an electroconductive non-magnetic layer and a free layer above a lower gap film;
forming an anti-ferromagnetic film and a lead layer on the free layer of said magnetoresistive film;
forming a first layer photo-resist pattern at a distance above said lead layer;
etching said lead layer and said anti-ferromagnetic film by using the photo-resist pattern;
forming a second layer photo-resist pattern on said magnetoresistive film where said lead layer and said anti-ferromagnetic film has been removed and said first layer photo-resist pattern;
etching said magnetoresistive film by using said first layer and said second layer photo-resist patterns, thereby forming a domain control film and an outer lead layer to a portion where said magnetoresistive film has been removed;
removing said first layer and said second layer photo-resist patterns; and
forming an upper gap film above said magnetoresistive film, said lead layer and said outer lead layer.

7. A method of manufacturing a magnetoresistive reproducing head according to claim 6, wherein a lower magnetic shield is formed below said lower gap film, and an upper magnetic shield is formed on said upper gap film.

8. A method of manufacturing a magnetoresistive reproducing head according to claim 6, wherein said magnetoresistive film, said anti-ferromagnetic film and said lead layer are continuously formed without breaking vacuum.

9. A method of manufacturing a magnetoresistive reproducing head comprising the steps of:
forming a lower magnetic shield on a substrate;
forming a lower gap film on said lower magnetic shield;
forming a magnetoresistive film, an anti-ferromagnetic film and a lead layer above said lower gap film;
forming a first layer photo-resist pattern at a distance above said lead layer;
etching said lead layer and said anti-ferromagnetic film by using the photo-resist pattern;
forming a second layer photo-resist pattern on said magnetoresistive film where said lead layer and said anti-ferromagnetic film have been removed and said first layer photo-resist pattern;
etching said magnetoresistive film by using said first layer and said second layer photo-resist patterns, thereby forming a domain control film and an outer lead layer to a portion where said magnetoresistive film has been removed;
removing said first layer and said second layer photo-resist patterns;
forming an upper gap film above said magnetoresistive film, said lead layer and said outer lead layer;
forming an upper magnetic shield above said upper gap film; and
forming an inductive recording head having: a lower magnetic layer and an upper magnetic layer formed on said upper magnetic shield by way of an insulator film; and a coil disposed between said lower magnetic film and said upper magnetic film by way of a magnetic gap and an insulation film.

10. A magnetoresistive reproducing head comprising:
a lower magnetic shield stacked on a substrate;
a lower gap film, a magnetoresistive film;
domain control films disposed on both ends of said magnetoresistive film;
lead layers formed on said domain control films and the both ends of said magnetoresistive film each with a riding amount of 100 nm or less in right-to-left symmetry;
an upper gap film formed above said lead layer and said magnetoresistive film; and
an upper magnetic shield formed on said upper gap film.

11. A magnetoresistive head comprising:
a magnetoresistive reproducing head including: a lower magnetic shield stacked on a substrate; a lower gap film; a magnetoresistive film; domain control films disposed on both ends of said magnetoresistive film; lead layers formed on said domain control films and the both ends of said magnetoresistive film each with a riding amount of 100 nm or less in right-to-left symmetry; an upper gap film formed above said lead layer and said magnetoresistive film; and an upper magnetic shield formed on said upper gap film, and
forming an inductive recording head having: a lower magnetic layer and an upper magnetic layer formed on said upper magnetic shield of said magnetoresistive reproducing head by way of an insulator film; and a coil disposed between said lower magnetic film and said upper magnetic film by way of a magnetic gap and an insulation film.
